(19) United States
(12) Patent Application Publication
(10) Pub. No.: US 2006/0209372 A1
(43) Pub. Date: Sep. 21, 2006

(54) Scanning device

(75) Inventor: Naohiro Tada, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/216,037

(22) Filed: Sep. 1, 2005

(30) Foreign Application Priority Data
Mar. 16, 2005 (JP) 2005-75009

(51) Int. Cl. G02B 26/08

(52) U.S. Cl. 359/196; 359/212

(57) ABSTRACT

A surface emitting laser light source is provided on a circuit board. Laser light emitted from the surface emitting laser light source scans a surface-to-be-scanned. A beam separator, which separates the laser light emitted from the surface emitting laser light source by reflecting a portion of the laser light, is disposed on an optical path between the surface emitting laser light source and the surface-to-be-scanned. The laser light, which is separated by the beam separator, is incident on a light-receiving element which detects a light amount thereof. The light-receiving element is provided on the circuit board at which the surface emitting laser light source is provided.

### CROSS-REFERENCE TO RELATED APPLICATION

This application claims priority under 35 USC 119 from Japanese Patent Application No. 2005-75009, the disclosure of which is incorporated by reference herein.

### BACKGROUND OF THE INVENTION

1. Field of the Invention

The present invention relates to a light scanning device, and in particular, to a light scanning device which forms an image on a photosensitive surface by using a surface emitting laser as a light source.

2. Description of the Related Art

Among light scanning devices which deflect a laser beam by a deflecting means such as a rotating polygon mirror or the like and scan-expose the surface of a photosensitive drum, there are light scanning devices using a surface emitting laser (VCSEL) as the light source. However, a light scanning device using a surface emitting laser has problems such as the following.

Namely, a surface emitting laser does not generate rearwardly exiting light such as an end surface exiting type semiconductor laser. Therefore, it has been thought to insert a beam separator in the optical system through which the forwardly exiting light, which becomes the light to be used, passes, and to split-off a portion of the forwardly exiting laser light at this beam separator (splitter) so as to use this light as monitor light.

Structures in which the position of the beam separator at this time is between the VCSEL and a collimator lens, or between the collimator lens and an aperture (aperture element or aperture unit), or at the aperture surface, have been proposed (see, for example, Japanese Patent Application Laid-Open (JP-A) No. 06-31980).

However, in cases in which the beam separator is disposed before the aperture, if there is dispersion in the divergence (spread) angles of the respective beams, the ratio of the amount of light of the reflected beam heading toward a light-receiving element to the amount of light of the beam passing through the aperture fluctuates, and a difference in the light amounts of the beams arises.

Further, if the driving current of the surface emitting laser is increased, the surface emitting laser initially emits light in a single mode, but gradually changes to multimode, and therefore, the profile of the laser changes. Moreover, even in the single mode region, in a vicinity of the oscillation threshold value (current value), the divergence angle is wide, and if the driving current is increased, there is the behavior that the divergence angle gradually becomes small.

Therefore, if, for example, as shown in FIG. 7, an aperture 66 is provided after a half-mirror 64 which serves as a beam splitter, and the beam diameter of a surface emitting laser 70 which is directed toward a photosensitive drum is shaped, the vignetting (eclipsing) amount of the beam due to the aperture 66 fluctuates also in accordance with-changes in the driving current.

Accordingly, the ratio of the light amount of the laser beam which is reflected at the half-mirror 64 and is directed toward a light-receiving element 68, to the light amount of the laser beam which passes through the half-mirror 64 and whose beam diameter is shaped at the aperture 66 and which reaches the photosensitive drum, differs in accordance with the dispersion in the divergence angles of the beams and the driving current, and accurate light amount control cannot be carried out.

Thus, a structure has been proposed in which a beam separator is disposed after the aperture (see, for example, JP-A No. 2002-40350). However, although control can be carried out with respect to the difference in the light amounts of the beams, because the circuit board of the surface emitting laser and the light-receiving element are structured as separate bodies, a detection signal at the light-receiving element is fed-back to the circuit board of the surface emitting laser via a harness. In this structure, there is the risk that noise will be picked-up from the exterior of the harness, and there is the possibility that the signal detected at the light-receiving element cannot be fed-back accurately.

Thus, as structures in which a harness is not interposed, there are a structure in which a light-receiving element is provided at the circuit board of a surface emitting laser (see, for example, JP-A No. 06-31980), and a structure in which a surface emitting laser and a light-receiving element are on the same package (see, for example, JP-A No. 10-100476).

However, in the structure disclosed in JP-A No. 06-31980, although noise is not picked-up at the harness as described above, when there is dispersion in the divergence angles of the respective beams, a difference in the light amounts of the beams arises, and accurate light amount control cannot be carried out. Further, in the structure disclosed in JP-A No. 10-100476, because the beams and the light-receiving elements are provided in a one-to-one relationship, there is a large number of light-receiving elements. Further, because the light-receiving elements are provided in the extremely narrow gaps between the light-emitting points, when the alignment of the optical system is adjusted, there is the concern that the beams which are directed toward the light-receiving elements may come out of place, and such adjustment is extremely difficult.

### SUMMARY OF THE INVENTION

In view of the aforementioned, the present invention provides a light scanning device which may improves the accuracy of detecting the light amounts of a surface emitting laser, and in which, even if alignment adjustment is carried out, the accuracy of detecting the light amount of a laser beam at a light-receiving element does not deteriorate.

A first aspect of the present invention is a light scanning device comprising; laser beams that are collimated at a collimator lens and shaped at an aperture, a light deflector that deflects the laser beams to scan and expose a surface to be scanned, a beam separator which reflects a portion of the laser beam, a surface emitting laser that is provided on a circuit board and emitting the laser beams; and a light-receiving element that receives a portion of the laser beams reflected by the beam separator and detects the light amount of the laser beams, wherein the light-receiving element is disposed on the same circuit board as the surface emitting laser.

A second aspect of the present invention is a light scanning device comprising; laser beams that are collimated at a collimator lens and shaped at an aperture, a light deflector that deflects the laser beams to scan and expose a surface to be scanned, a beam separator which reflects a portion of the laser beams, a surface emitting laser that emitts the laser beams; and a light-receiving element that receives a portion of the laser beams reflected by the beam separator and detecting the light amount of the laser beams, wherein the light-receiving element is provided on a same package as the surface emitting laser.

A third aspect of the present invention is a light scanning device that scans a surface to be scanned by a laser light, the light scanning device comprising: a surface emitting laser light source that is provided on a circuit board and emitts the laser light; a beam separator that is disposed on an optical path between the surface emitting laser light source and the surface-to-be scanned, and separates the laser light by reflecting a portion of the laser light; and a light-receiving element that receives the laser light separated by the beam separator, and detects a light amount of the laser light, the light-receiving element being provided on the circuit board.

### BRIEF DESCRIPTION OF THE DRAWINGS

The embodiments of the present invention will be described in detail based on the following figures, wherein:

FIG. 1 is a perspective view of a light scanning device relating to a first embodiment of the present invention;

FIGS. 2A and 2B are optical path diagrams of the light scanning device relating to the first embodiment of the present invention, where FIG. 2A shows a state seen from a tangential direction, and FIG. 2B shows a state seen from a sagittal direction;

FIGS. 3A and 3B are optical path diagrams of a light scanning device relating to a second embodiment of the present invention, where FIG. 3A shows a state seen from a tangential direction, and FIG. 3B shows a state seen from a sagittal direction;

FIGS. 4A and 4B are optical path diagrams of a light scanning device relating to a third embodiment of the present invention, where FIG. 4A shows a state seen from a tangential direction, and FIG. 4B shows a state seen from a sagittal direction;

FIG. 4C is a perspective view of a beam splitter used in the third embodiment;

FIG. 5 is a perspective view of a beam splitter used in a fourth embodiment of the present invention;

FIGS. 6A and 6B are optical path diagrams of a light scanning device relating to a fifth embodiment of the present invention, where FIG. 6A shows a state seen from a tangential direction, and FIG. 6B shows a state seen from a sagittal direction; and

FIG. 7 is a diagram showing the arrangement of an aperture and a half-mirror in a conventional light scanning device.

### DETAILED DESCRIPTION OF THE INVENTION

(Summary of Light Scanning Device)

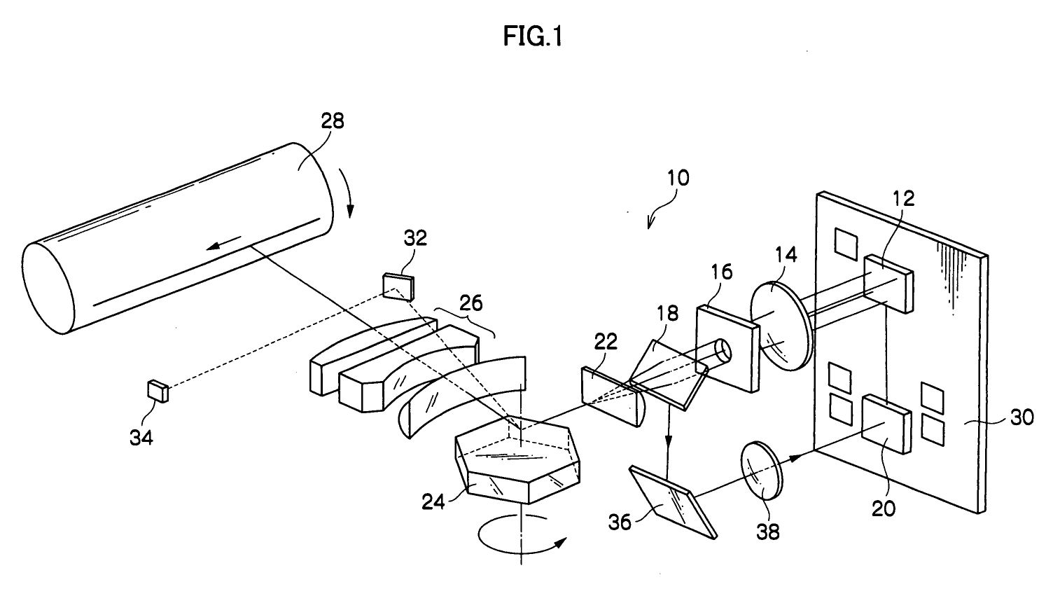

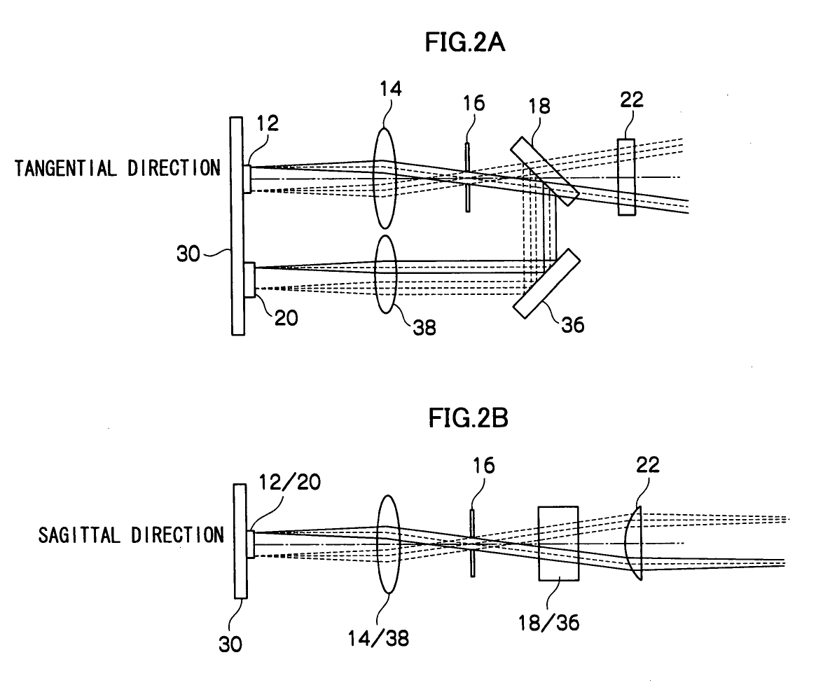

The structure of a light scanning device relating to a first embodiment of the present invention is shown in FIGS. 1 and 2.

As shown in FIG. 1, in a light scanning device 10 relating to the first embodiment, a surface emitting laser 12 (VCSEL) is used as the light source.

The surface emitting laser 12 is provided, together with a light-receiving element (MPD: Monitor Photo Diode) 20 which photoelectrically converts laser beams and outputs signals for carrying out output control, on a same substrate 30.

After the laser beams exiting from the surface emitting laser 12 are made into parallel light (collimated) by a collimator lens 14, the beam diameters are shaped by an aperture 16 before the laser beams head toward a half-mirror 18.

As shown in FIGS. 1 and 2, the aperture (aperture element) 16 is disposed at the image side focal point position of the collimator lens 14. The plurality of laser beams, which exit in parallel from the surface emitting laser 12, intersect at the position of the aperture 16. Therefore, the plurality of laser beams can be shaped equally by the one aperture 16.

The laser beams, whose beam diameters are shaped by the aperture 16, are reflected by the half-mirror 18, and are separated into laser beams which head toward the light-receiving element 20 which detects the strength of the laser beams, and laser beams which pass through the half-mirror 18 and are narrowed-in in the subscanning direction by a cylindrical lens 22 and made incident on the reflecting surfaces of a rotating polygon mirror 24.

The laser beams which are incident on the rotating polygon mirror 24 are deflected accompanying the rotation, such that spot images are image-focused onto a photosensitive drum 28 by an imaging lens 26 (an fθ lens), and an electrostatic latent image corresponding to image information is formed on the photosensitive drum 28.

A reflecting mirror 32 is disposed outside of the image range at the start-of-scan side on the scan line. The laser beams which are reflected by this reflecting mirror 32 are detected at an SOS sensor 34, and the image writing timing in the main scanning direction is controlled.

On the other hand, the amounts of light of the laser beams, which are reflected by the half-mirror 18 and further reflected by a mirror 36 toward the circuit board 30 and are incident on the light-receiving element 20, are photoelectrically converted at the light-receiving element 20 and transferred to the circuit board 30 as output signals. When the light output signals of the laser beams, which were photoelectrically converted at the light-receiving element 20, are inputted to a control section (not shown) provided at the circuit board 30, the driving current is controlled at the control section such that the surface emitting laser 12 becomes a predetermined output.

In the present embodiment, because the surface emitting laser 12 is used as the light source, the divergence (spread) angles and the profiles of the beams exiting from the surface emitting laser 12 vary in accordance with variations in the driving current.

Further, as described above, when the beam separator is disposed before the aperture, in a case in which there is dispersion in the divergence angles of the respective beams, the ratio of the light amounts of the reflected beams heading toward the light-receiving element to the light amounts of the beams passing through the aperture fluctuates, and a difference in the light amounts of the beams arises.

However, by disposing the aperture 16 before the half-mirror 18, the vignetting (eclipsing) effect due to the aperture 16 is expressed similarly in both the laser beams directed toward the photosensitive drum 28 and the laser beams directed toward the light-receiving element 20. Therefore, the linearity of the light amounts on the photosensitive drum 28 and on the light-receiving element 20 is no longer affected by fluctuations in the divergence angles.

Further, when the circuit board 30 of the surface emitting laser 12 and the light-receiving element 20 are structured as separate bodies, the detection signals at the light-receiving element 20 are fed-back to the circuit board 30 of the surface emitting laser 12 via a harness (a wire harness). In this structure, noise is picked-up by the harness, and the detection signals cannot be fed-back accurately. Thus, in the present embodiment, the surface emitting laser 12 and the light-receiving element 20 are set on the one circuit board 30 as a structure in which a harness is not disposed therebetween.

The plurality of laser beams which intersect at the position of the aperture 16 thereafter gradually separate, and the positions of the plural laser beams on the light-receiving element 20 are offset. Therefore, it is preferable that the light-receiving surface area of the light-receiving element 20 be larger than the plural beam diameters. Further, as shown in FIGS. 2A and 2B, by placing a collecting lens 38 between the half-mirror 18 and the light-receiving element 20, the light-receiving surface area of the light-receiving element 20 can be made to be small.

In the present embodiment, due to the above-described structure, the half-mirror 18 which is a beam separator is disposed after the beams are shaped at the aperture 16. Therefore, even if there is dispersion in the divergence angles of the respective beams, the ratio of the amounts of light, which are reflected at the half-mirror 18 and directed toward the light-receiving element 20, to the amounts of light of the beams which are transmitted through the aperture 16 and used in exposure, is constant, and a difference in the light amounts of the beams does not arise. Further, even if alignment adjustment (XYθ: coordinates and angle) is carried out, because the positional relationship between the surface emitting laser 12 and the light-receiving element 20 is invariable, the accuracy of detecting the light amount of the surface emitting laser 12 does not deteriorate.

By providing the surface emitting laser 12 and the light-receiving element 20 on the same circuit board 30, when the detection signals at the light-receiving element 20 are fed-back to the circuit board 30 of the surface emitting laser 12 via a harness, because the harness is not interposed therebetween, there is no risk that the harness will pick-up noise from the exterior, and the signals detected at the light-receiving element 20 can be accurately fed-back to the surface emitting laser 12.

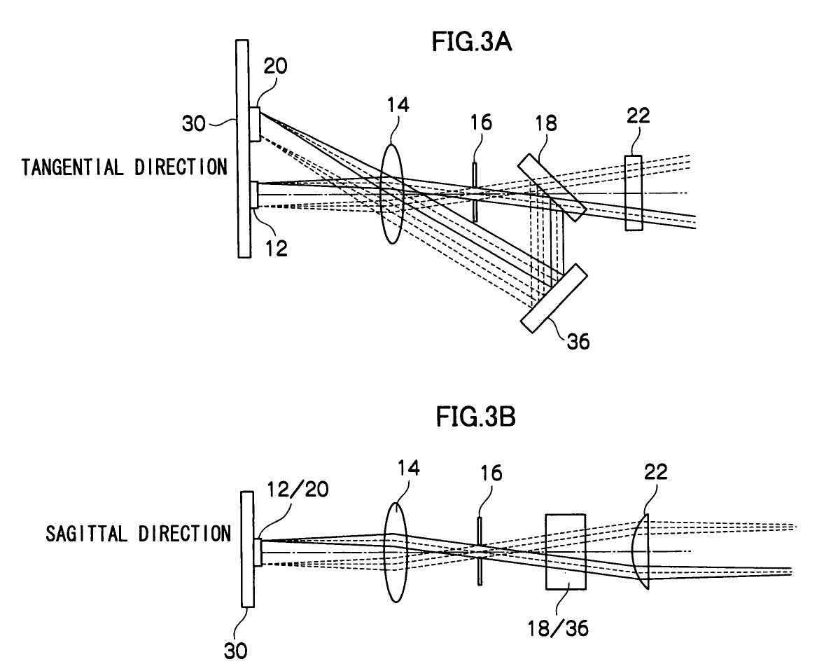

The light source section of a light scanning device relating to a second embodiment of the present invention is shown in FIGS. 3A and 3B.

As shown in FIGS. 3A and 3B, the laser beams, which exit from the surface emitting laser 12 of the light scanning device relating to the second embodiment, are made into parallel light (collimated) by the collimator lens 14, and thereafter, the beam diameters are shaped by the aperture 16 before the beams head toward the half-mirror 18.

As shown in FIGS. 3A and 3B, the aperture 16 is disposed at the image side focal point position of the collimator lens 14. The plurality of laser beams, which exit in parallel from the surface emitting laser 12, intersect at the position of the aperture 16. Therefore, the fact that the plural laser beams can be shaped equally by the one aperture 16 is the same as in the first embodiment.

The laser beams, whose beam diameters have been shaped by the aperture 16, are divided into laser beams, which are reflected by the half-mirror 18 and directed toward the light-receiving element 20 which detects the strength of the laser beams, and laser beams, which pass through the half-mirror 18 and are narrowed-in in the subscanning direction by the cylindrical lens 22 and made incident on the light-reflecting surfaces of the rotating polygon mirror 24.

In the present embodiment, the laser beams, which are reflected by the half-mirror 18 and are further reflected toward the circuit board 30 and are incident on the light-receiving element 20, are reflected by the mirror 36 and are again made to pass through the collimator lens 14. An optical system from which the collecting lens 38 is omitted is thereby formed.

In the present embodiment, due to the above-described structure, it is possible to form an optical system from which the collecting lens 38 is omitted and which is more simple and has fewer parts. Therefore, the light scanning device can be made to be more compact and less expensive.

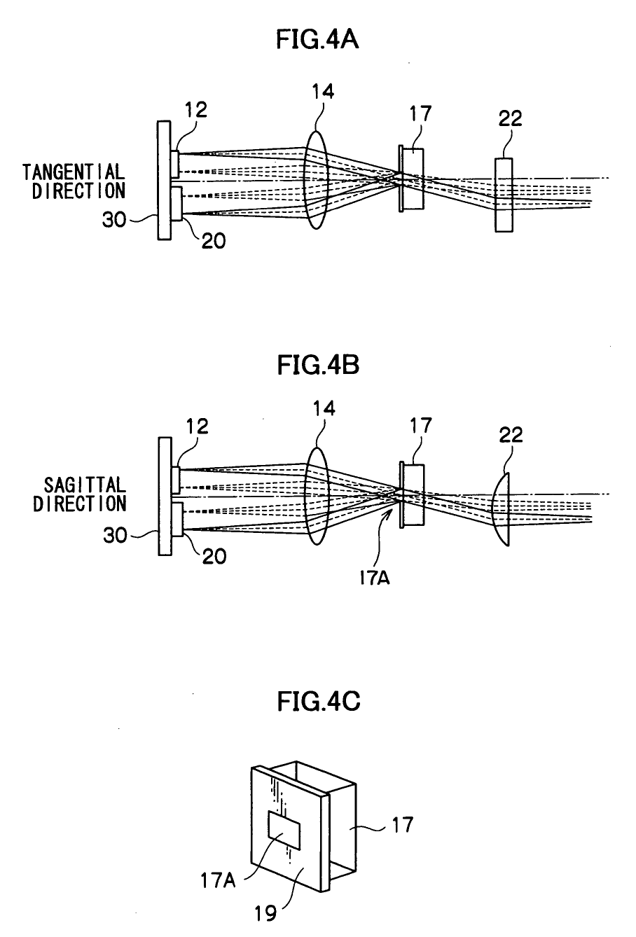

The light source section of a light scanning device relating to a third embodiment of the present invention is shown in FIGS. 4A, 4B, and 4C.

As shown in FIGS. 4A and 4B, the laser beams, which exit from the surface emitting laser 12 of the light scanning device relating to the third embodiment, are made into parallel light (collimated) by the collimator lens 14, and thereafter, the beam diameters are shaped by a beam splitter 17 in which a half-mirror and an aperture are formed integrally.

As shown in FIGS. 4A and 4B, the beam splitter 17 is disposed at the image side focal point position of the collimator lens 14. The plurality of laser beams, which exit in parallel from the surface emitting laser 12, intersect at the position of an opening portion 17A of an aperture (aperture element) 19 which is provided at the incident side of the beam splitter 17.

In the same way as the half-mirror 18 of the first and second embodiments, the opening portion 17A which is shown in FIG. 4C reflects a portion of the incident beams and transmits a portion of the incident beams. Therefore, in the same way as in the first embodiment, the plural laser beams can be shaped equally by the one beam splitter 17.

A portion of the incident laser beams is reflected at the opening portion 17A of the aperture 19 which is provided at the incident side of the beam splitter 17 in which the half-mirror and the aperture are made integral, such that the incident laser beams are separated into laser beams heading toward the light-receiving element 20 which detects the strength of the laser beams, and laser beams which pass through the opening portion 17A and are narrowed-in in the subscanning direction by the cylindrical lens 22 and made incident on the light-reflecting surface of the rotating polygon mirror 24.

In the present embodiment, in accordance with the above-described structure, the half mirror and the aperture are made integral as the beam splitter, and it is possible to form an optical system which is more simple and has fewer parts. Therefore, the light scanning device can be made to be more compact and less expensive. Further, by making the half mirror and the aperture integral, there is no fear that the positional relationship between the two will vary, and beams can be shaped and separated accurately over a longer period of time.

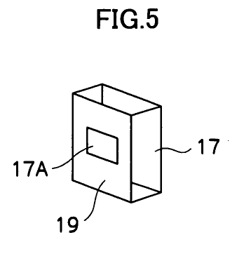

A beam splitter of a light scanning device relating to a fourth embodiment of the present invention is shown in FIG. 5.

As shown in FIG. 5, in the beam splitter 17 relating to the fourth embodiment, a portion of the incident surface side of the half-mirror remains as the opening portion 17A, and the surface therearound is subjected to a reflection-preventing mask processing.

In the present embodiment, in accordance with the above-described structure, it is possible to construct an optical system which is more simple and has fewer parts as compared with the third embodiment in which the half-mirror and the aperture are made integral as the beam splitter. Therefore, costs can be reduced even more. Further, by making the half mirror and the aperture integral, there is no fear that the positional relationship between the two will vary, and beams can be shaped and separated accurately over a longer period of time.

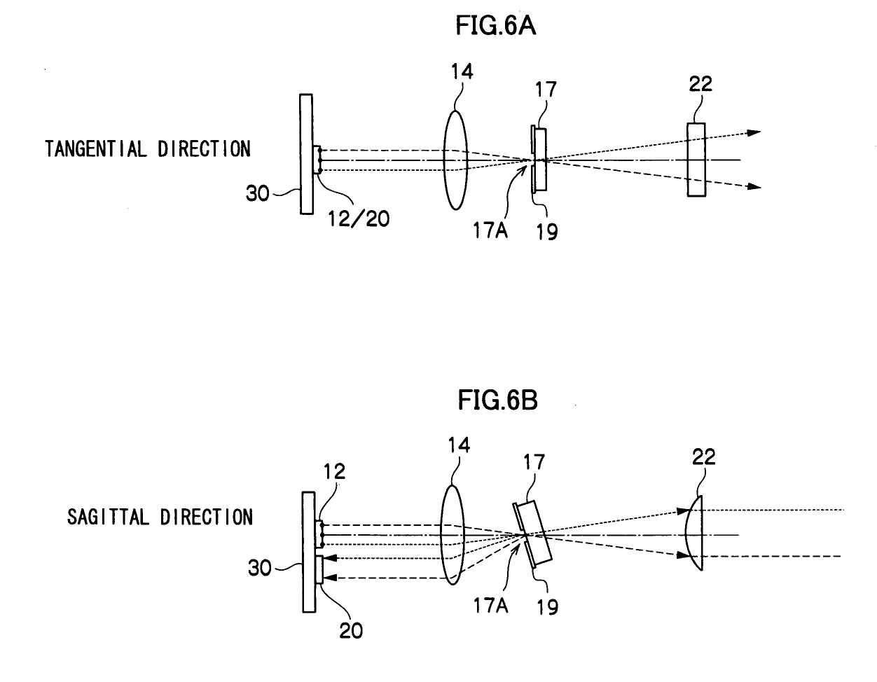

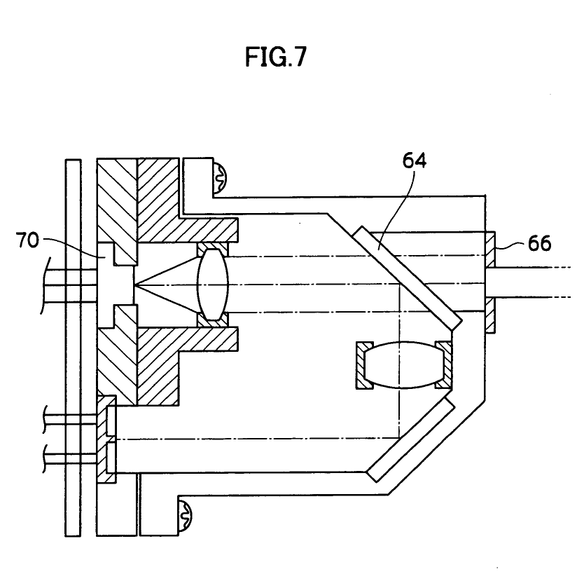

The light source section of a light scanning device relating to a fifth embodiment of the present invention is shown in FIGS. 6A and 6B.

As shown in FIGS. 6A and 6B, the laser beams, which exit from the surface emitting laser 12 of the light scanning device relating to the fifth embodiment, are made into parallel light (collimated) by the collimator lens 14, and thereafter, the beam diameters are shaped by an aperture 19 before the beams head toward the half mirror 17.

The fifth embodiment is similar to the second embodiment shown in FIGS. 3A and 3B with respect to the point that the collecting lens is omitted. The aperture 19 is disposed at the image side focal point position of the collimator lens 14. The plurality of laser beams, which exit in parallel from the surface emitting laser 12, intersect at the position of the aperture 19. Therefore, the fact that the plural laser beams can be shaped equally by the one aperture 19 is the same as in the first embodiment.

The laser beams, whose beam diameters are shaped by the aperture 19, are separated into laser beams, which are reflected by the half-mirror 17 and head toward the light-receiving element 20 which detects the strength of the laser beams, and laser beams, which pass through the half-mirror 17 and are narrowed-in in the subscanning direction by the cylindrical lens 22 and made incident on the light-reflecting surfaces of the rotating polygon mirror 24.

In the present embodiment, the laser beams, which are reflected by the half-mirror 17 and are further reflected toward the circuit board 30 and are incident on the light-receiving element 20, are reflected by the mirror 17 and are again made to pass through the collimator lens 14. An optical system from which a collecting lens is omitted is thereby formed.

In the present embodiment, in accordance with the above-described structure, it is possible to form an optical system from which the collecting lens 36 of the second embodiment is omitted and which is more simple and has fewer parts. Therefore, the light scanning device can be made to be more compact and less expensive.

Although the present invention is described above on the basis of specific embodiments of the present invention, the present invention is not to be interpreted as being limited to these embodiments.

Namely, a first aspect of the present invention is a light scanning device in which laser beams, which are collimated at a collimator lens and shaped at an aperture, are deflected by a light deflector and scan-expose a surface-to-be-scanned, and which is provided with a beam separator which reflects a portion of the laser beams, the light scanning device including: a surface emitting laser provided on a circuit board and emitting the laser beams; and a light-receiving element receiving a portion of the laser beams reflected by the beam separator and detecting the light amount thereof, wherein the light-receiving element is disposed on the same circuit board as the surface emitting laser.

In the invention of the above-described structure, the light-receiving element, which photometrically measures the laser beams which have been collimated by the collimator lens and shaped by the aperture, is provided on the same circuit board as the surface emitting laser (the surface emitting laser light source). In this way, the light amount detection accuracy improves, and even if alignment adjustment is carried out, the accuracy of detecting the light amounts of the laser beams at the light-receiving element does not deteriorate.

A second aspect of the present invention is a light scanning device in which laser beams, which are collimated at a collimator lens and shaped at an aperture, are deflected by a light deflector and scan-expose a surface-to-be-scanned, and which is provided with a beam separator which reflects a portion of the laser beams, the light scanning device including: a surface emitting laser emitting the laser beams; and a light-receiving element receiving a portion of the laser beams reflected by the beam separator and detecting the light amount thereof, wherein the light-receiving element is provided on a same package as the surface emitting laser.

In the above-described aspect, a light-receiving element, which photometrically measures laser beams which have been collimated by the collimator lens and shaped by the aperture, is provided on the same package as the surface emitting laser. In this way, the light amount detection accuracy improves, and even if alignment adjustment is carried out, the accuracy of detecting the light amounts of the laser beams at the light-receiving element does not deteriorate.

The light scanning device of the above-described first or second aspect may be structured such that the laser beams reflected by the beam separator are again incident on the collimator lens, and the light amounts thereof are detected by the light-receiving element.

In the above-described structure, due to the laser beams, which are reflected at the beam separator, being made incident again on the collimator lens, a collecting lens can be omitted, and an optical system having a simple structure can be formed.

In the light scanning device of the above-described first or second aspect, the beam separator may be formed integrally with the aperture. In this case, a portion of the laser beams is reflected at the opening portion of the aperture, and the light amount thereof is detected at the light-receiving element.

In this structure, by forming the beam separator integrally with the aperture, the positional accuracy of the beam separator and the aperture can be maintained high, and the number of parts can be reduced.

In the light scanning device of the above-described first or second aspect, an incident side region of the aperture, other than the opening portion, may be subjected to a reflection preventing mask processing.

In the above-described structure, by forming the incident side region of the aperture, other than the opening portion, by reflection preventing mask processing, the positional accuracy of the beam separator and the aperture can be maintained high, and the number of parts can be reduced.

Moreover, in the light scanning device of the above-described structure, the aperture and the beam separator may be inclined with respect to the optical axis.

In the above-described structure, the optical axes of the beams, which are emitted from the surface emitting laser and are used in the scan-exposure, are not offset with respect to the optical system after the aperture and the beam separator. Therefore, a good optical performance can be maintained.

The present invention can provide a light scanning device which improves the accuracy of detecting the light amounts of a surface emitting laser, and in which, even if alignment adjustment is carried out, the accuracy of detecting the light amounts of laser beams at a light-receiving element does not deteriorate.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light scanning device comprising;
laser beams that are collimated at a collimator lens and shaped at an aperture,
a light deflector that deflects the laser beams to scan and expose a surface to be scanned,
a beam separator which reflects a portion of the laser beam,
a surface emitting laser that is provided on a circuit board and emitting the laser beams; and
a light-receiving element that receives a portion of the laser beams reflected by the beam separator and detects the light amount of the laser beams,
wherein the light-receiving element is disposed on the same circuit board as the surface emitting laser.

2. A light scanning device comprising;
laser beams that are collimated at a collimator lens and shaped at an aperture,
a light deflector that deflects the laser beams to scan and expose a surface to be scanned,
a beam separator which reflects a portion of the laser beams,
a surface emitting laser that emitts the laser beams; and
a light-receiving element that receives a portion of the laser beams reflected by the beam separator and detecting the light amount of the laser beams,
wherein the light-receiving element is provided on a same package as the surface emitting laser.

3. The light scanning device of claim 1, wherein the laser beams reflected by the beam separator are incident on the collimator lens again, and are incident on the light-receiving element.

4. The light scanning device of claim 1, wherein the beam separator is formed integrally with the aperture, and a portion of the laser beams is reflected at an opening portion of the aperture and is incident on the light-receiving element.

5. The light scanning device of claim 1, wherein an incident side region of the aperture, other than the opening portion, is subjected to a reflection preventing mask processing.

6. The light scanning device of claim 1, wherein the aperture and the beam separator are disposed so as to be inclined with respect to an optical axis.

7. A light scanning device that scans a surface to be scanned by a laser light, the light scanning device comprising:
a surface emitting laser light source that is provided on a circuit board and emitts the laser light;
a beam separator that is disposed on an optical path between the surface emitting laser light source and the surface-to-be scanned, and separates the laser light by reflecting a portion of the laser light; and
a light-receiving element that receives the laser light separated by the beam separator, and detects a light amount of the laser light, the light-receiving element being provided on the circuit board.

8. The light scanning device of claim 7, further comprising a collimator lens which collimates the laser light emitted from the surface emitting laser light source, and an aperture which shapes the laser light collimated by the collimator lens, wherein the collimator lens and the aperture are disposed at an upstream side of the beam separator on the optical path.

9. The light scanning device of claim 8, wherein the aperture is disposed at an image side focal point position of the collimator lens.

10. The light scanning device of claim 8, wherein the laser light separated by the beam separator is incident on the light-receiving element via the collimator lens.

11. The light scanning device of claim 8, wherein the beam separator is formed integrally with the aperture.

12. The light scanning device of claim 8, wherein the aperture has an opening portion through which the laser light is transmitted, and an incident side region of the aperture, other than the opening portion, is subjected to a reflection preventing mask processing.

13. The light scanning device of claim 11, wherein the aperture and the beam separator are formed integrally, and both the aperture and the beam separator are disposed so as to be inclined to an optical axis.
